(19) United States
(12) Patent Application Publication
(10) Pub. No.: US 2022/0132978 A1
(43) Pub. Date: May 5, 2022

(54) SOLE, SHOES, SOLE MANUFACTURING METHOD, AND SOLE TWIST CONTROL SYSTEM

(71) Applicant: ASICS CORPORATION, Hyogo (JP)

(72) Inventors: Seiichi UENO, Hyogo (JP); Wataru UEDA, Hyogo (JP); Ippei SHIINA, Hyogo (JP); Kentaro YAMASHITA, Hyogo (JP); Mikiya MIYAMOTO, Hyogo (JP); Kenta MORIYASU, Hyogo (JP); Masanori SAKAGUCHI, Hyogo (JP)

(21) Appl. No.: 17/438,598

(22) PCT Filed: Mar. 29, 2019
(86) PCT No.: PCT/JP2019/014384

§ 371 Date: Sep. 13, 2021

(51) Int. Cl. A43B 7/24; A43B 5/06; B29D 35/12; A43B 3/34; A43B 13/14; A43B 3/24

(52) U.S. Cl. CPC A43B 7/24; A43B 5/06; A43B 3/246; A43B 3/34; A43B 13/141; B29D 35/122

(57) ABSTRACT

A sole includes a buffer member extending along an axis connecting a toe and a heel, the buffer member being twisted around the axis along at least part of the axis.

### CROSS-REFERENCE T0 RELATED APPLICATIONS

This application is a U.S. National Stage application of International Application No. PCT/JP2019/014384, filed Mar. 29, 2019, the contents of which are hereby incorporated herein by reference.

### BACKGROUND

### Field of the Invention

The present invention relates to a sole, a shoe, a method for manufacturing a sole, and a twist control system for a sole.

### Background Information

Shoes used for sports or the like preferably follow the motion of foot portions of the wearer during walking, running, or exercising, for example, and also firmly support the feet.

Japanese Translation of PCT International Application Publication No. 2008-526269 discloses a sole including a diagonally twisted plate. A midsole as a buffer member is disposed on the plate.

Also, in the reference by James Becker, Stanley James, Robert Wayner, Louis Osternig, Li-Shan Chou, “Biomechanical Factors Associated With Achilles Tendinopathy and Medial Tibial Stress Syndrome in Runners,” The American Journal of Sports Medicine, Vol. 45, No. 11, pp. 2614-2620 FIG. 1 shows the comparison results regarding abduction of a foot at the time of landing between controlled runners and injured persons. The comparison results show that the period of abduction continues for a long time in the case of injured persons, whereas, in the case of controlled runners, the period of abduction is shorter, and the abduction shifts to adduction early.

### SUMMARY

Although PCT International Application Publication No. 2008-526269 states that a twisted sole enables natural human motion, with the line of loading moving diagonally inwards from the lateral heel to the thenar eminence and the hallux, it does not mention the movement and deformation of the sole. Also, it has been found that there is room for improving the functions of shoes by promoting the foot movement of shifting from abduction to adduction at an early stage, as described in the reference by James Becker, Stanley James, Robert Wayner, Louis Osternig, Li-Shan Chou, “Biomechanical Factors Associated With Achilles Tendinopathy and Medial Tibial Stress Syndrome in Runners.

The present invention has been made in view of such an issue, and a purpose thereof is to provide a sole, a shoe, a method for manufacturing a sole, and a twist control system for a sole, which can assist foot movement using twisting deformation.

An aspect of the present invention relates to a sole. The sole includes a buffer member that extends along an axis connecting a toe and a heel. The buffer member is twisted around the axis along at least part of the axis.

A sole of another aspect includes a buffer member that extends between a toe side and a heel side. The buffer member is formed such that, in a lateral part, the toe side and the heel side become higher than a middle part between the toe side and the heel side.

Yet another aspect of the present invention relates to a method for manufacturing a sole. The method for manufacturing a sole includes: filling a resin material into a mold for a buffer member that extends along an axis connecting a toe and a heel and that is twisted around the axis along at least part of the axis; and forming the buffer member by heating the resin material.

Still yet another aspect of the present invention relates to a shoe. The shoe includes: a sole including a buffer member that extends along an axis connecting a toe and a heel and that is twisted around the axis along at least part of the axis; and an actuator that changes a twist angle of the buffer member.

A further aspect of the present invention relates to a twist control system for a sole. The twist control system for a sole includes: a sole including a buffer member that extends along an axis connecting a toe and a heel and that is twisted around the axis along at least part of the axis; an actuator that changes a twist angle of the buffer member; a control unit that drives and controls the actuator; and a road surface information device that acquires information regarding a road surface with which the sole is in contact, based on position information. Based on the information regarding a road surface acquired by the road surface information device, the control unit changes a twist angle.

Optional combinations of the aforementioned constituting elements, and implementation of the present invention, including the constituting elements and expressions, in the form of methods or apparatuses can also be practiced as additional modes and embodiments of the present invention.

With embodiments of the present invention, foot movement can be assisted using twisting deformation.

### BRIEF DESCRIPTION OF DRAWINGS

The invention will be explained in more detail hereinafter with reference to the drawings.

FIG. 1 is an exploded perspective view that illustrates an external view of a shoe according to a first embodiment;

FIG. 2 is a schematic diagram used to describe positional relationships between a plan view of a sole and a skeleton model of a human foot;

FIG. 3 is a bottom view of the sole;

FIGS. 4A, 4B, 4C, 4D, and 4E are sectional views of the sole taken along the respective cutting plane lines including line A-A shown in FIG. 3;

FIG. 5 is a graph that shows an example of foot pronation at the time of landing;

FIG. 6 is a perspective view that illustrates an external view of a sole according to a second embodiment;

FIG. 7 is a plan view of the sole;

FIG. 8 is a bottom view of the sole;

FIGS. 9A, 9B, 9C, 9D, and 9E are sectional views of the sole taken along the respective cutting plane lines including line A-A shown in FIG. 8;

FIG. 10 is a perspective view that illustrates an external view of a sole according to a third embodiment;

FIG. 11 is a plan view of the sole;

FIG. 12 is a bottom view of the sole;

FIGS. 13A, 13B, 13C, 13D, and 13E are sectional views of the sole taken along the respective cutting plane lines including line A-A shown in FIG. 12;

FIG. 14 is a flowchart that shows a forming process of a midsole;

FIG. 15 is a block diagram that shows a functional configuration of a twist control system for a sole according to a fourth embodiment; and

FIG. 16 is a perspective view that illustrates an external view of an actuator of an adjustment device.

### DETAILED DESCRIPTION

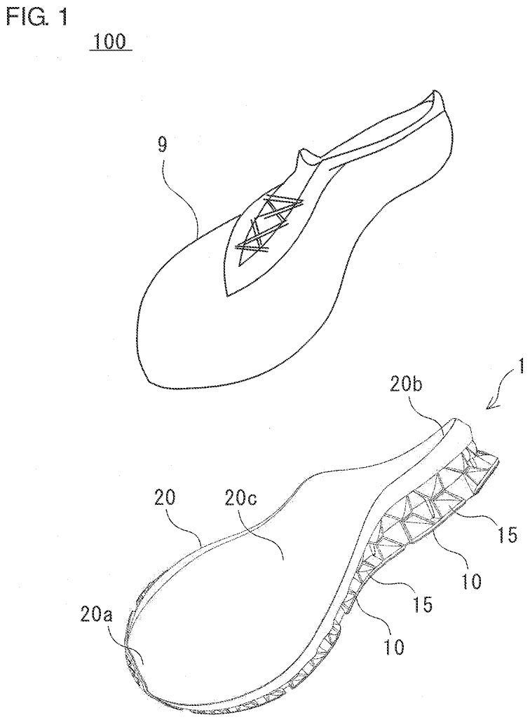

In the following, the present invention will be described based on preferred embodiments with reference to FIGS. 1 through 16. Like reference characters denote like or corresponding constituting elements and members in each drawing, and repetitive description will be omitted as appropriate. Also, the dimensions of a member can be appropriately enlarged or reduced in each drawing in order to facilitate understanding. Further, in each drawing, part of a member less important in describing embodiments can be omitted.

### First Embodiment

FIG. 1 is an exploded perspective view that illustrates an external view of a shoe 100 according to the first embodiment. The shoe 100 includes an upper 9 and a sole 1. The upper 9 is bonded to or sewed onto a circumferential edge part of the sole 1 to cover the upper side of a foot. The sole 1 includes an outer sole 10 and a midsole 20, for example, and is configured by laminating the midsole 20 on the outer sole 10 and further laminating an insole or the like thereon, which is not illustrated. The shoe 100 illustrated in FIG. 1 is used for a left foot.

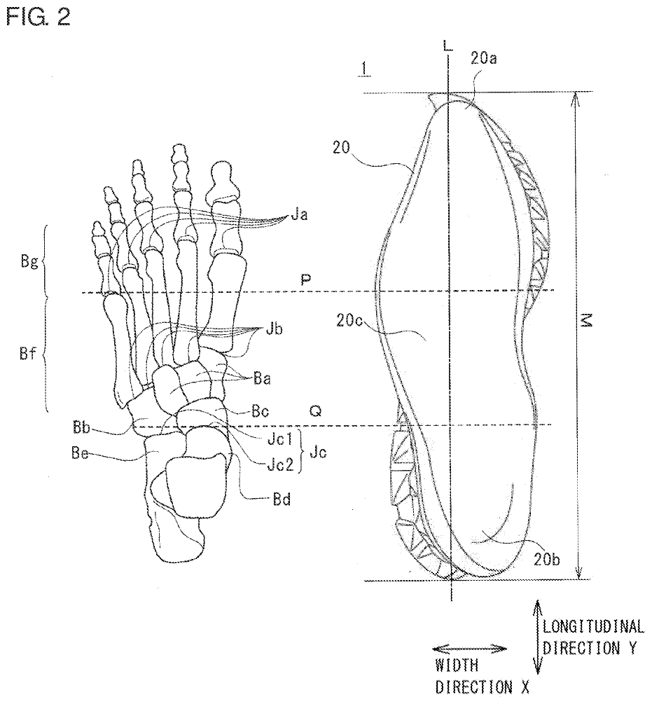

FIG. 2 is a schematic diagram used to describe positional relationships between a plan view of the sole 1 and a skeleton model of a human foot. As shown in FIG. 2, a human foot is mainly constituted by cuneiform bones Ba, a cuboid bone Bb, a navicular bone Bc, a talus Bd, a calcaneus Be, metatarsal bones Bf, and phalanges Bg. Joints of a foot include MP joints Ja, Lisfranc joints Jb, and a Chopart's joint Jc. The Chopart's joint Jc includes a calcaneocuboid joint Jc1 formed by the cuboid bone Bb and the calcaneus Be, and a talocalcaneonavicular joint Jc2 formed by the navicular bone Bc and the talus Bd.

In this embodiment of the present invention, a longitudinal direction Y of the sole 1 is defined as a direction of a straight line L that connects the toe and the heel, and a width direction X of the sole 1 is defined as a direction that intersects the longitudinal direction Y and a vertical direction (omitted in the drawing). A longitudinal direction Y can be a direction in which the outer dimension or inner dimension between the toe and the heel of the sole 1 becomes maximum or can be a direction of a straight line that connects the middle of the heel side and the middle of the toe side, for example. A line P represents a straight line that extends along a width direction X, which is a direction perpendicular to the straight line L, and that is assumed to pass through the heel-side end of the MP joints Ja. Also, a line Q represents a straight line that extends along a width direction X and that is assumed to pass through the toe-side end of the Chopart's joint Jc of the wearer. Hereinafter, a region from the line P to the toe is referred to as a forefoot portion, a region from the line P to the line Q is referred to as a midfoot portion, and a region from the line Q to the heel is referred to as a rearfoot portion. With regard to the relationship between the lines P, Q and the shoe 100, the line P is positioned within a range from 40% to 75% of the entire length M of the shoe 100 from the rear end on the heel side in a longitudinal direction Y, for example. More preferably, the line P is positioned within a range from 55% to 70% from the rear end. Also, the line Q is positioned within a range from 20% to 45% of the entire length M of the shoe 100 from the rear end on the heel side in a direction of the straight line L. More preferably, the line Q is positioned within a range from 25% to 40% from the rear end.

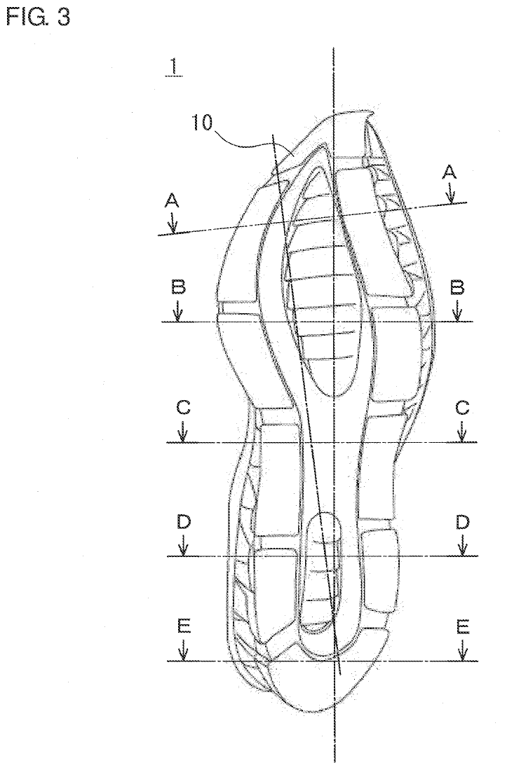

FIG. 3 is a bottom view of the sole 1. A bottom surface portion of the outer sole 10, which comes into contact with a road surface, is formed along the entire foot length in a longitudinal direction Y and is also formed to be curled up to protect the toe. Although the outer sole 10 illustrated in FIG. 3 is discretely disposed along a circumferential edge of the sole 1, the outer sole 10 can be continuously formed. Between an upper surface of the outer sole 10 and the midsole 20, a gel member 15 is disposed. As with the outer sole 10, the gel member 15 can also be discretely disposed along a circumferential edge of the sole 1 or can be continuously disposed. For the gel member 15, a material having lower hardness than the outer sole 10 and the midsole 20 is used so as to reduce local loads caused by bumps and dips on a road surface and to absorb impact at the time of landing.

The midsole 20 is disposed on the outer sole 10 and formed to extend from the toe to the heel. In a free state without any load, the midsole 20 is twisted medially or laterally along a length from a toe 20a to a heel 20b of the midsole 20. When the midsole 20 is regarded as one rod-like object extending along a longitudinal direction Y, it can be considered that the rod-like midsole 20 is twisted around its central axis. The central axis of the midsole 20 can be obtained by finding the center of the figure on each cross section continuously in a longitudinal direction and connecting the centers. The central axis of the midsole 20 corresponds to an axis connecting the toe and the heel in the present invention and can form a straight line, a curved line, or a combined line partially including a straight line and a curved line, depending on the shape of the midsole 20. Also, the midsole 20 corresponds to a buffer member in this embodiment of the present invention.

Although the midsole 20 illustrated in FIG. 1 is twisted overall along a longitudinal direction Y, the midsole 20 can be partially twisted. The midsole 20 is twisted medially from a middle part 20c between the toe 20a and the heel 20b toward the heel 20b and twisted laterally from the middle part 20c toward the toe 20a.

In the midsole 20, the rearfoot portion is twisted medially with respect to the midfoot portion, and the forefoot portion is twisted laterally with respect to the midfoot portion. The midsole 20 can be configured such that the forefoot portion, the midfoot portion, or the rearfoot portion is partially twisted, for example. Also, the midsole 20 can be configured such that a portion from the forefoot portion to the midfoot portion or a portion from the midfoot portion to the rearfoot portion is partially twisted.

The outer sole 10 can be formed of rubber, a resin, or a composite material of rubber and a resin, for example. The midsole 20 can be formed of resin foam, for example. As a resin, a thermoplastic resin (a nylon resin material, for example) such as thermoplastic polyamides (TPA), or a thermoplastic resin such as TPU and ethylene-vinyl acetate copolymer (EVA) can be used, for example. The resin can contain other arbitrary components, as appropriate. By configuring the outer sole 10 as a hard member having higher hardness than the midsole 20, the durability of the shoe 100 can be improved, and deformation of the shoe 100 in a vertical direction can be restrained.

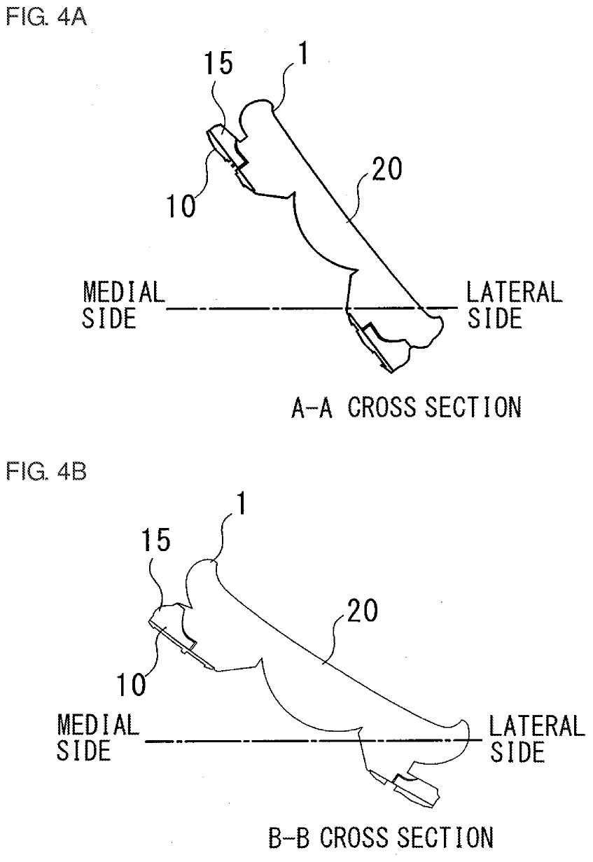

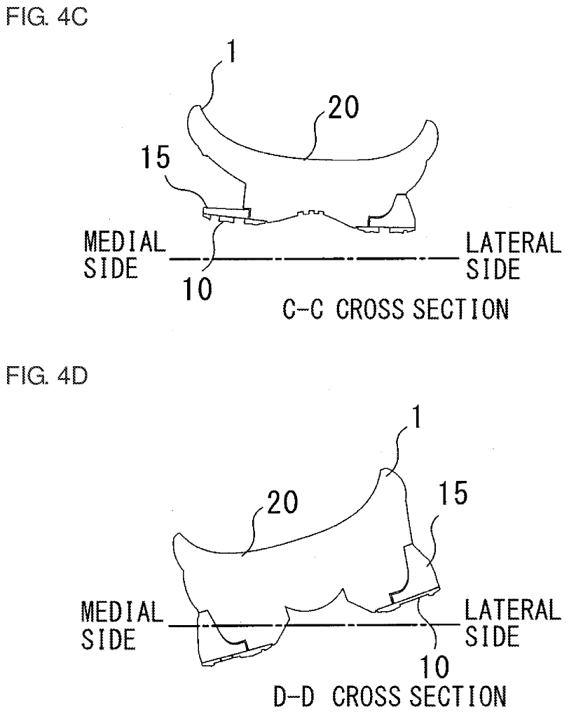

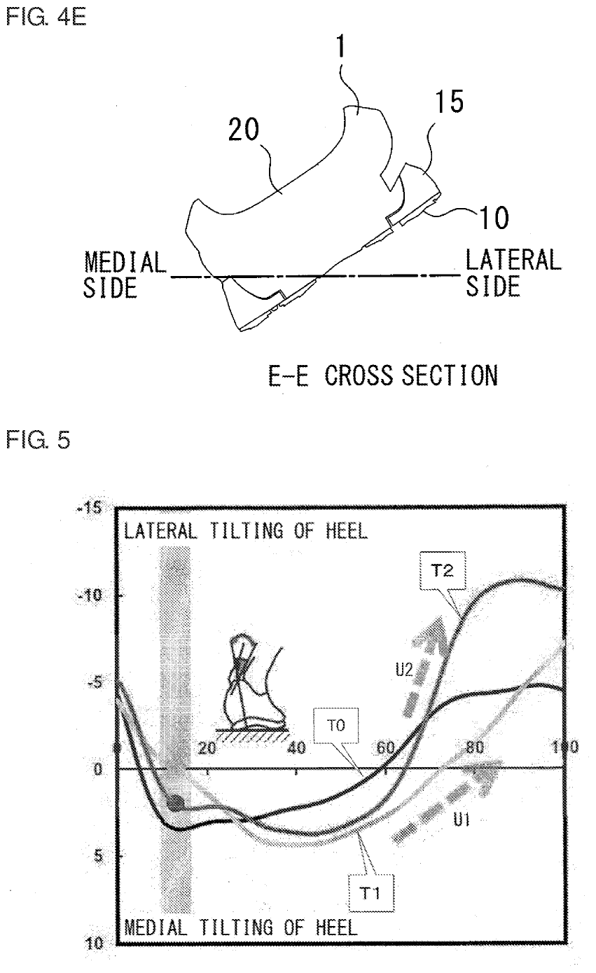

There will now be described the functions of the shoe 100 according to the first embodiment. FIGS. 4A, 4B, 4C, 4D, and 4E are sectional views of the sole 1 taken along the respective cutting plane lines including line A-A shown in FIG. 3. From the C-C cross section in the midfoot portion illustrated in FIG. 4C toward the toe 20a side, the midsole 20 is gradually twisted laterally, as shown in the B-B cross section illustrated in FIG. 4B and the A-A cross section illustrated in FIG. 4A. Also, from the C-C cross section in the midfoot portion toward the heel 20b side, the midsole 20 is gradually twisted medially, as shown in the D-D cross section illustrated in FIG. 4D and the E-E cross section illustrated in FIG. 4E. When a wearer of the shoe 100 walks or runs, the heel 20b side of the foot lands first, and the rearfoot portion, the midfoot portion, and the forefoot portion then come into contact with the road surface in sequence. At the time, a portion of the twisted midsole 20 in contact with the road surface is deformed such as to decrease the twist, and such deformation generates resilience.

For example, after the rearfoot portion lands, while both the E-E cross section and the D-D cross section are in contact with the road surface, the twist between the E-E cross section and the D-D cross section becomes small in a free state. On the E-E cross section and the D-D cross section, resilience to return to the original twisted state is generated. Thereafter, when the heel 20b side of the rearfoot portion moves away from the road surface, the resilience in the midsole 20 makes the heel side of the foot to lift more easily, so as to assist the foot movement during the walking or running.

When the midfoot portion and the forefoot portion of the foot sequentially land, the resilience is also generated on the C-C cross section, the B-B cross section, and the A-A cross section in sequence. Thereafter, also when the midfoot portion and the forefoot portion of the foot move away from the road surface, the resilience makes the foot to lift from the road surface more easily, so as to assist the foot movement at the time of pushing off during walking or running. With the midsole 20 made of nylon resin as a thermoplastic resin of TPA, for example, the resilience can be made greater, which can instantly generate repulsion for lifting the foot from the road surface.

The midsole 20 is twisted by about 90 degrees, as shown in the A-A cross section in FIG. 4A and the E-E cross section in FIG. 4E. However, the angle of the twist is not limited thereto and can be an arbitrary angle. For example, when the resilience needs to be smaller for a wearer with less pronation, the angle of the twist of the midsole 20 can be set to 45 degrees or less, for example. Thus, variations of the angle of the twist can be set based on individual differences.

FIG. 5 is a graph that shows an example of foot pronation at the time of landing. The pronation of the shoe 100 according to the first embodiment is indicated by a line T1. Also, an example of a non-twisted shoe is indicated by a line T0. As indicated by the line T1, at the time of landing, the amount of pronation is less, and the time for which the foot tilts medially is shorter. Also, the speed of recovering from the medial tilting, indicated by an arrow U1 in FIG. 5, is slightly higher than that of the non-twisted shoe.

The sole 1 is constituted by the outer sole 10, the gel member 15, and the midsole 20, for example, but these components can be integrally formed as the midsole 20. In this case, the midsole 20 can be made of one material and include the functions of the outer sole 10 and the gel member 15, or two or more kinds of materials can be used to integrally form the midsole 20. Within the sole 1, a wire extending in a longitudinal direction Y can be provided to restrain the deformation in a vertical direction, for example.

### Second Embodiment

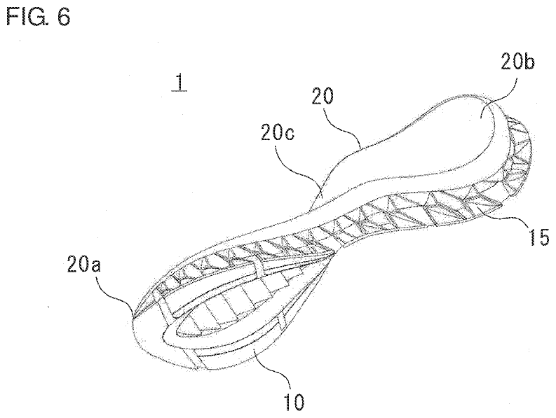

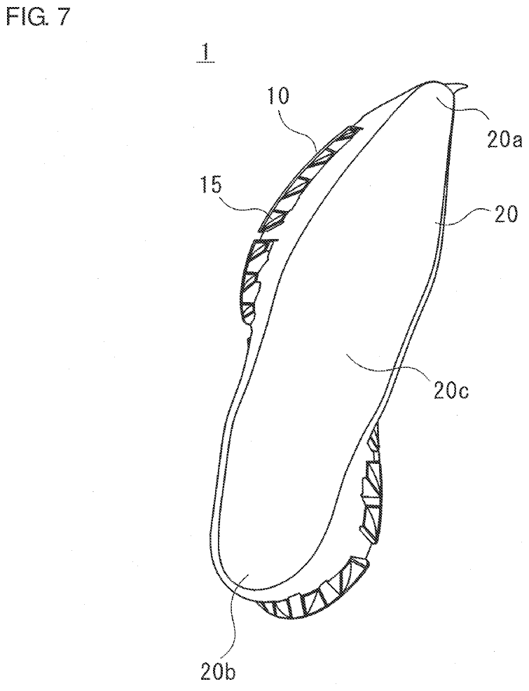

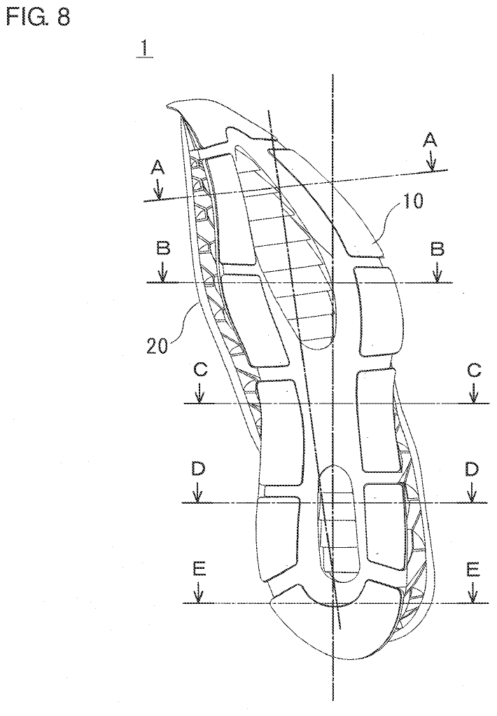

FIG. 6 is a perspective view that illustrates an external view of the sole 1 according to the second embodiment. FIG. 7 is a plan view of the sole 1, and FIG. 8 is a bottom view of the sole 1. As is the case in the first embodiment, the sole 1 according to the second embodiment is also constituted by the outer sole 10, the gel member 15, and the midsole 20, for example. The sole 1 illustrated in FIG. 6 or the like is used for a left foot. With regard to the sole 1 according to the second embodiment, configurations, materials, functions, and the like other than those particularly described below are similar to those in the first embodiment.

In a free state without any load, the midsole 20 is twisted medially or laterally along a length from the toe 20a to the heel 20b of the midsole 20. The midsole 20 is twisted laterally from the middle part 20c toward the heel 20b and twisted medially from the middle part 20c toward the toe 20a.

In the midsole 20, the rearfoot portion is twisted laterally with respect to the midfoot portion, and the forefoot portion is twisted medially with respect to the midfoot portion. The midsole 20 can be configured such that the forefoot portion, the midfoot portion, or the rearfoot portion is partially twisted, for example. Also, the midsole 20 can be configured such that a portion from the forefoot portion to the midfoot portion or a portion from the midfoot portion to the rearfoot portion is partially twisted.

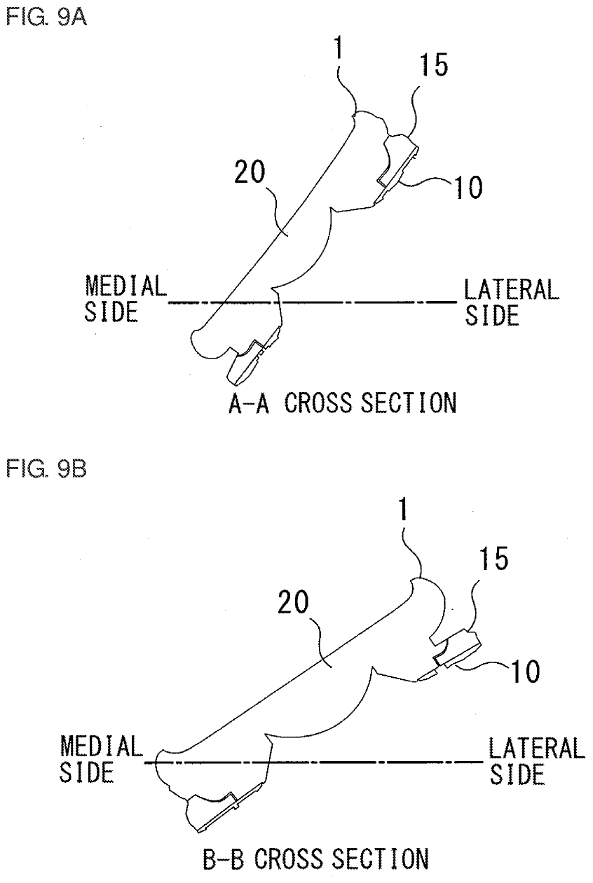

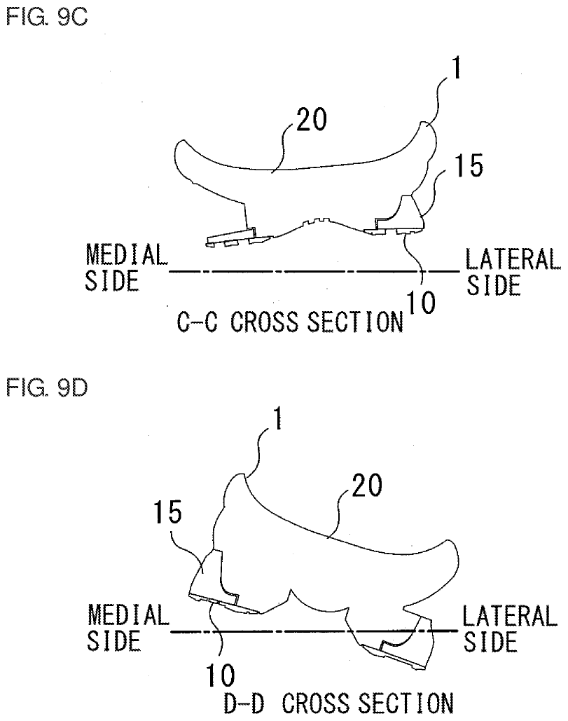

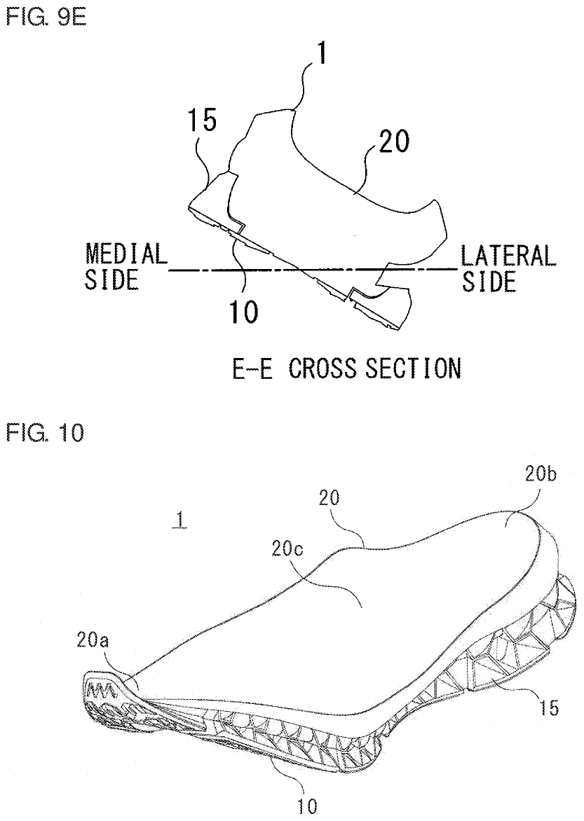

FIGS. 9A, 9B, 9C, 9D, and 9E are sectional views of the sole 1 taken along the respective cutting plane lines including line A-A shown in FIG. 8. From the C-C cross section in the midfoot portion illustrated in FIG. 9C toward the toe 20a side, the midsole 20 is gradually twisted medially, as shown in the B-B cross section illustrated in FIG. 9B and the A-A cross section illustrated in FIG. 9A. Also, from the C-C cross section in the midfoot portion toward the heel 20b side, the midsole 20 is gradually twisted laterally, as shown in the D-D cross section illustrated in FIG. 9D and the E-E cross section illustrated in FIG. 9E. When a wearer of the shoe 100 walks or runs, a portion of the twisted midsole 20 in contact with a road surface is deformed such as to decrease the twist, and such deformation generates resilience.

For example, when the rearfoot portion lands, the twist between the E-E cross section and the D-D cross section becomes small, and the resilience to return to the original twisted state is generated. Thereafter, when the heel 20b side of the rearfoot portion moves away from the road surface, the resilience in the midsole 20 makes the heel side of the foot to lift more easily, so as to assist the foot movement during the walking or running. The resilience also generates force to push up the lateral side on the E-E cross section, thereby restraining underpronation of the wearer's foot.

When the midfoot portion and the forefoot portion of the foot sequentially land, the resilience is also generated on the C-C cross section, the B-B cross section, and the A-A cross section in sequence. Thereafter, also when the midfoot portion and the forefoot portion of the foot move away from the road surface, the resilience makes the foot to lift from the road surface more easily, so as to assist the foot movement at the time of pushing off during the walking or running. The midsole 20 is twisted by about 90 degrees, as shown in the A-A cross section in FIG. 9A and the E-E cross section in FIG. 9E. However, the angle of the twist is not limited thereto and can be an arbitrary angle.

An example of pronation of the sole 1 according to the second embodiment is indicated by a line T2 in FIG. 5. The pronation of the sole 1 immediately after the landing in the second embodiment is slightly larger than that in the first embodiment (the line T1) but is smaller than that in the case of the non-twisted shoe (the line T0). Also, the sole 1 according to the second embodiment favorably recovers from the pronation, and the pronation becomes zero earlier compared to the first embodiment. Further, the speed of recovering from the medial tilting, indicated by an arrow U2 in FIG. 5, is higher than that in the first embodiment. The resilience generates a stronger force to push up the medial side, thereby restraining overpronation of the wearer's foot.

### Third Embodiment

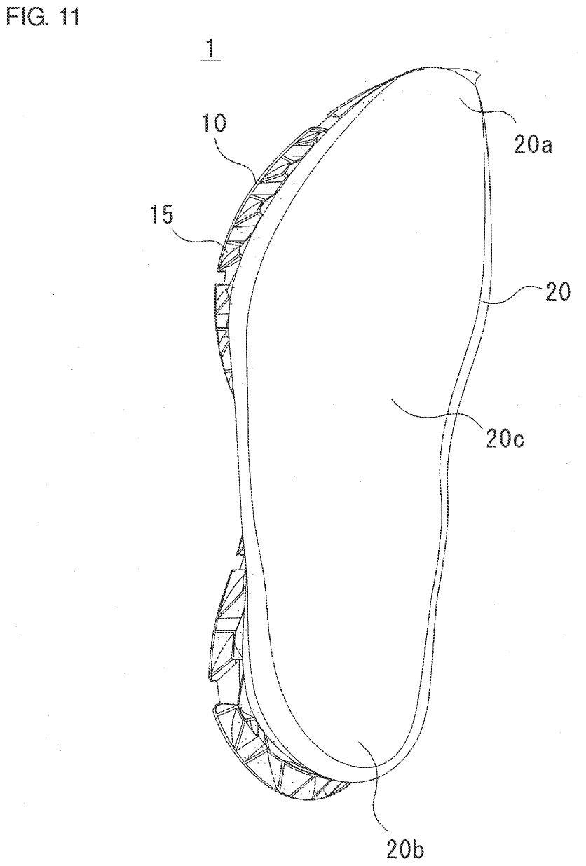

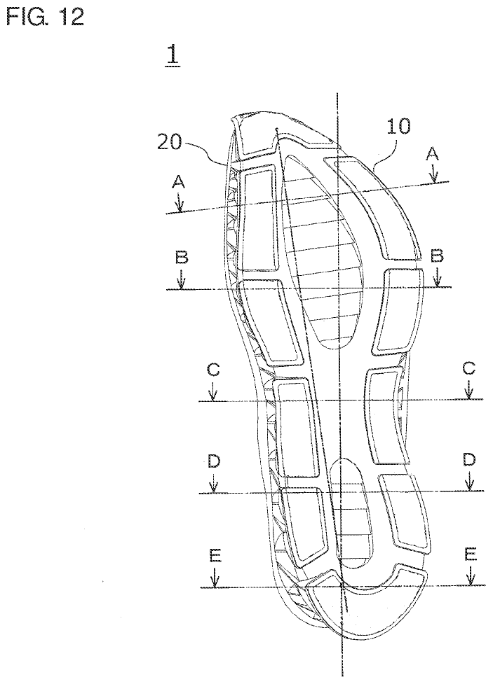

FIG. 10 is a perspective view that illustrates an external view of the sole 1 according to the third embodiment. FIG. 11 is a plan view of the sole 1, and FIG. 12 is a bottom view of the sole 1. As is the case in the first embodiment, the sole 1 according to the third embodiment also includes the outer sole 10, the gel member 15, and the midsole 20, for example. The sole 1 illustrated in FIG. 10 or the like is used for a left foot. With regard to the sole 1 according to the third embodiment, configurations, materials, functions, and the like other than those particularly described below are similar to those in the first embodiment.

In a free state without any load, the midsole 20 is twisted medially or laterally along a length from the toe 20a to the heel 20b of the midsole 20. The midsole 20 is twisted medially from the middle part 20c toward the heel 20b and also twisted medially from the middle part 20c toward the toe 20a. The midsole 20 is formed such that, in a lateral part, the toe 20a side and the heel 20b side become higher than the middle part 20c. In the midsole 20, the rearfoot portion is twisted medially with respect to the midfoot portion, and the forefoot portion is also twisted medially with respect to the midfoot portion. The midsole 20 can be twisted medially from the center of the central axis of the midsole toward the toe 20a and twisted medially from the center of the central axis toward the heel 20b, for example.

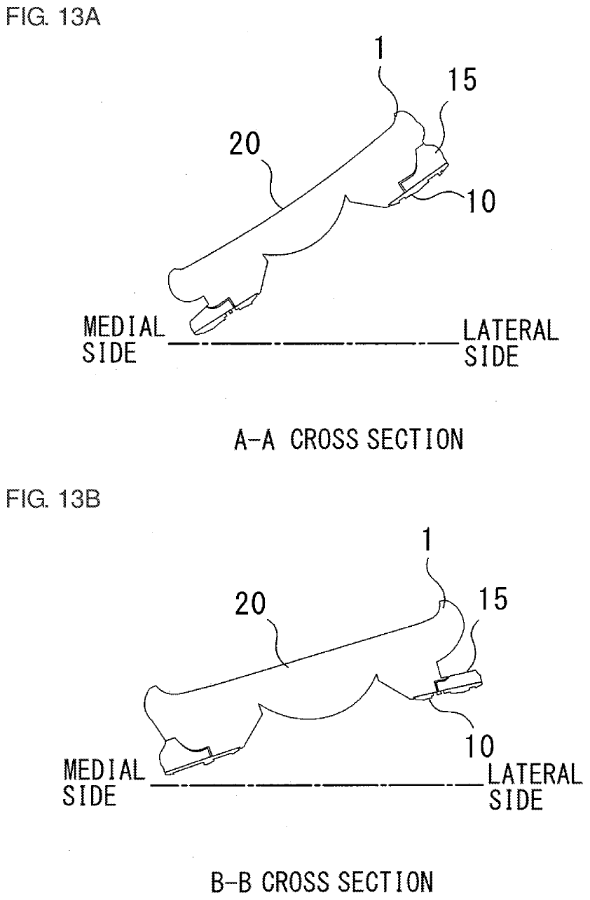

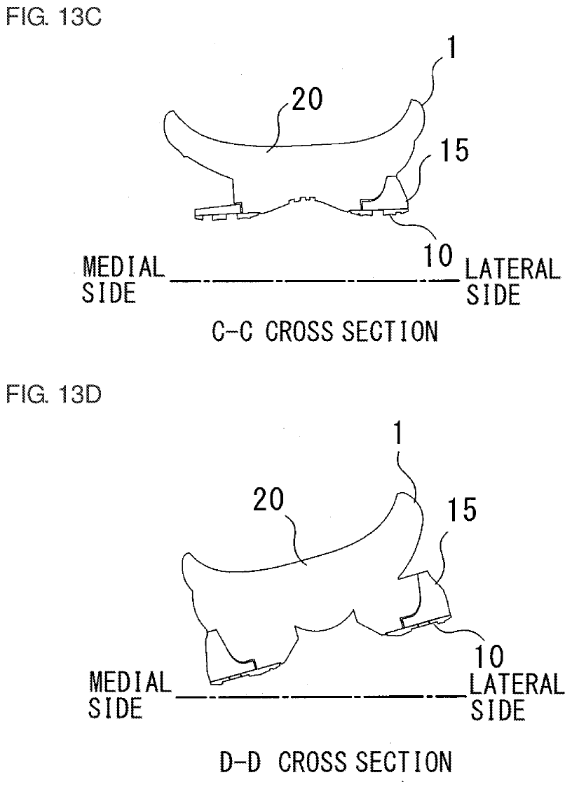

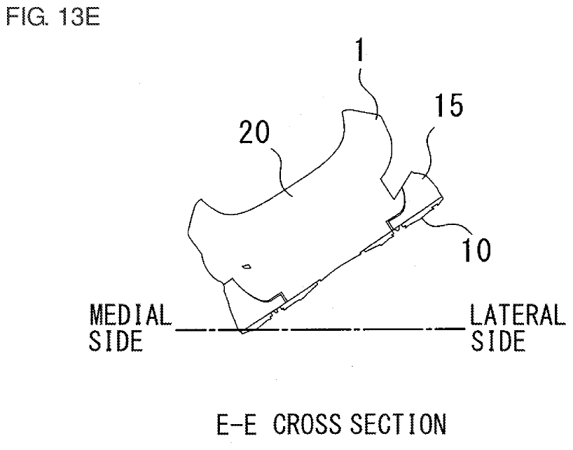

FIGS. 13A, 13B, 13C, 13D, and 13E are sectional views of the sole 1 taken along the respective cutting plane lines including line A-A shown in FIG. 12. From the C-C cross section in the midfoot portion illustrated in FIG. 13C toward the toe 20a side, the midsole 20 is gradually twisted medially, as shown in the B-B cross section illustrated in FIG. 13B and the A-A cross section illustrated in FIG. 13A. Also, from the C-C cross section in the midfoot portion toward the heel 20b side, the midsole 20 is gradually twisted medially, as shown in the D-D cross section illustrated in FIG. 13D and the E-E cross section illustrated in FIG. 13E. When a wearer of the shoe 100 walks or runs, a portion of the twisted midsole 20 in contact with a road surface is deformed such as to decrease the twist, and such deformation generates resilience.

For example, when the rearfoot portion lands, the twist between the E-E cross section and the D-D cross section becomes small, and the resilience to return to the original twisted state is generated. Thereafter, when the heel 20b side of the rearfoot portion moves away from the road surface, the resilience in the midsole 20 makes the heel side of the foot to lift more easily, so as to assist the foot movement during the walking or running. The resilience also generates force to push up the medial side on the E-E cross section, thereby restraining overpronation of the wearer's foot.

When the midfoot portion and the forefoot portion of the foot sequentially land, the resilience is also generated on the C-C cross section, the B-B cross section, and the A-A cross section in sequence. Thereafter, also when the midfoot portion and the forefoot portion of the foot move away from the road surface, the resilience makes the foot to lift from the road surface more easily, so as to assist the foot movement at the time of pushing off during the walking or running. The angle of the twist of the midsole 20 is not limited to that shown in FIG. 13 and can be an arbitrary angle.

### Method for Manufacturing the Sole

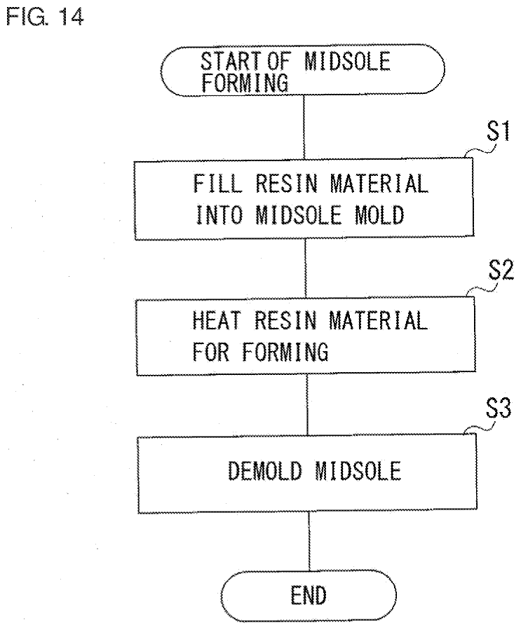

There will now be described a method for manufacturing the sole 1 according to each embodiment. FIG. 14 is a flowchart that shows a forming process of the midsole 20. To form and process the midsole 20, a mold constituted by one or more mold parts is produced based on the shape of the midsole 20, and preparations for the forming process are made. In a first forming process, a resin material is filled into the mold of the midsole 20 (51). For the resin material, foam particles or powder of aforementioned various thermoplastic resins can be used to be filled into the mold.

In a second forming process, the resin material filled into the mold is heated to form the midsole 20 (S2). In the process of forming the midsole 20 by heating the resin material, the process in which the resin material is foamed by the heating is included. Thereafter, in a third forming process, the midsole 20 thus formed is removed from the mold, i.e., demolded (S3).

By forming and processing the midsole 20 using foam particles, the weight of the midsole 20 can be reduced; by using nylon resin or the like, the resilience of the midsole 20 can be improved. The forming process of the midsole 20 can include a steam heating process and can include forming using light or microwaves and mold forming. Also, the midsole 20 can be formed by a 3D printer or can be formed by pressing deformation using a last.

The sole 1 is formed by bonding the outer sole 10, the gel member 15, and the midsole 20 together in a bonding process. The outer sole 10 and the gel member 15 can be processed in advance into a shape corresponding to the shape of the midsole 20 before the bonding. Alternatively, the outer sole 10 and the gel member 15 of sheet shape, plate shape, or block shape can be pressed onto the midsole 20 to be deformed and bonded to the midsole 20.

### Fourth Embodiment

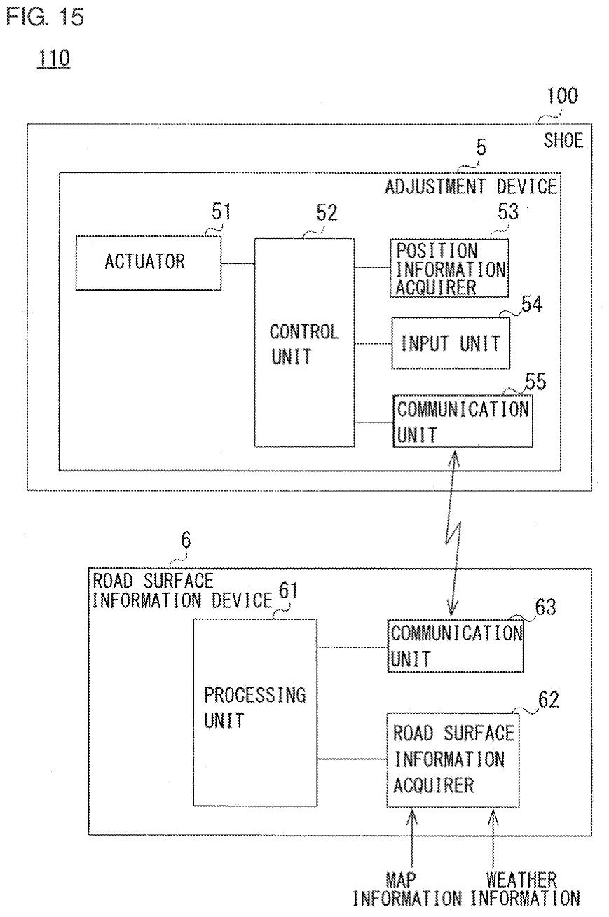

FIG. 15 is a block diagram that shows a functional configuration of a twist control system 110 for the sole 1 according to the fourth embodiment. Each block shown in FIG. 15 can be implemented by an electronic device, such as a CPU of a computer, or by a mechanical component in terms of hardware, and by a computer program or the like in terms of software. FIG. 15 illustrates functional blocks implemented by the cooperation of those components. Therefore, it will be obvious to those skilled in the art that the functional blocks can be implemented in a variety of forms by combinations of hardware and software. The twist control system 110 includes an adjustment device 5 and a road surface information device 6 and enables input setting for the twist angle of the sole 1 and automatic control of the twist angle based on road surface information.

The adjustment device 5 includes an actuator 51, a control unit (controller) 52, and a position information acquirer 53, for example. The actuator 51 is built into the shoe 100 and changes the twist angle of the midsole 20. The control unit 52 drives and controls the actuator 51. The control unit 52 acquires setting information from an input unit 54 into which a wearer can enter twist angle setting, and the control unit 52 drives the actuator 51 and adjusts the twist angle.

The control unit 52 also transmits position information including the current position to the road surface information device 6 via a communication unit 55, receives road surface information from the road surface information device 6, and adjusts the twist angle based on the road surface information thus received. The position information acquirer 53 can be a GPS receiver, for example, which receives a GPS signal to acquire the current position and outputs the current position to the control unit 52.

The road surface information device 6 includes a processing unit 61 and a road surface information acquirer 62, for example. The processing unit 61 receives position information from the adjustment device 5 via a communication unit 63 and outputs the position information to the road surface information acquirer 62. The road surface information acquirer 62 acquires, as the road surface information at the current position included in the position information thus input, a road surface gradient and rainfall information regarding the road surface at the current position, for example. The road surface gradient can be obtained based on map information, for example. Also, the rainfall information is obtained based on weather information. The processing unit 61 transmits the road surface information input from the road surface information acquirer 62 to the adjustment device 5 via the communication unit 63.

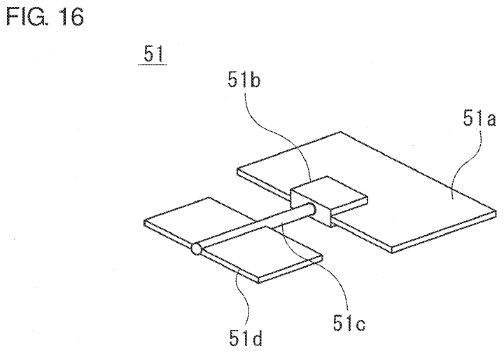

FIG. 16 is a perspective view that illustrates an external view of the actuator 51 of the adjustment device 5. In the actuator 51, a motor 51b is disposed on a base part 51a formed into a plate shape, for example, and, with the motor 51b driven, an output shaft 51c rotates. The output shaft 51c is disposed with an axial direction thereof set to a direction along a longitudinal direction Y (or the central axis of the midsole 20 described previously). The output shaft 51c includes a movable part 51d, and, with the movable part 51d of plate shape or the like rotating with the output shaft 51c, the twist angle can be adjusted.

The actuator 51 can be configured to adjust the twist angle of the midsole 20 using a method of causing twisting deformation of the movable portion by operation of a piezoelectric element, a magnetic fluid, or the like, or a method of causing twisting deformation by deformation of a bimetal, artificial muscle, or the like, for example.

With the sole 1, by adjusting the twist angle using the adjustment device 5, the resilience generated during walking or running can be adjusted. The wearer can adjust the twist angle based on individual differences and preference. Also, with the sole 1, by automatically adjusting the twist angle using the adjustment device 5 based on the road surface gradient and the rainfall information as the road surface information, the resilience of twisting deformation for assisting foot movement can be changed depending on the situation, for example.

The shoe 100 includes the sole 1 and the actuator 51. The sole 1 includes the midsole 20 extending along an axis that connects the toe 20a and the heel 20b. The midsole 20 is twisted around the axis along at least part of the axis. The actuator 51 changes the twist angle of the midsole 20. Accordingly, in the shoe 100, the resilience of twisting deformation for assisting foot movement can be changed depending on the individual differences and situation, for example.

The twist control system 110 for the sole 1 includes the sole 1, the actuator 51, the control unit 52, and the road surface information device 6. The sole 1 includes the midsole 20 extending along an axis that connects the toe 20a and the heel 20b. The midsole 20 is twisted around the axis along at least part of the axis. The actuator 51 changes the twist angle of the midsole 20. The control unit 52 drives and controls the actuator 51. The road surface information device acquires information regarding a road surface with which the sole 1 is in contact, based on the position information. Based on the information regarding the road surface acquired by the road surface information device 6, the control unit 52 changes the twist angle. Accordingly, the twist control system 110 for the sole 1 can change the twist angle of the midsole 20 based on the road surface information including the road surface gradient, for example.

There will now be described the features of the sole 1, the shoe 100, the method for manufacturing the sole 1, and the twist control system 110 for the sole 1, according to each embodiment.

The sole 1 includes the midsole 20 as a buffer member that extends along an axis connecting the toe 20a and the heel 20b, such as the central axis of the midsole 20. The midsole 20 is twisted around the central axis along at least part of the central axis. Accordingly, in the sole 1, resilience is generated by the twisting deformation at the time of landing, which can assist foot movement.

The midsole 20 can be twisted medially from the middle part 20c between the toe 20a and the heel 20b toward the heel 20b. Accordingly, the sole 1 can restrain pronation on the heel 20b side.

The midsole 20 can be twisted medially from the center of the central axis toward the toe 20a, for example. Accordingly, the sole 1 can assist the foot movement with the resilience at the time of pushing off.

Also, the midsole 20 can be twisted medially from the center of the central axis toward the heel 20b and also twisted medially from the center of the central axis toward the toe 20a, for example. Accordingly, the sole 1 can restrain pronation on the heel 20b side and also can assist the foot movement with the resilience at the time of pushing off.

The sole 1 includes the midsole 20 as a buffer member that extends between the toe 20a side and the heel 20b side. The midsole 20 is formed such that, in a lateral part, the toe 20a side and the heel 20b side become higher than the middle part 20c between the toe 20a side and the heel 20b side. Accordingly, the sole 1 can restrain pronation on the heel 20b side and also can assist the foot movement with the resilience at the time of pushing off

The shoe 100 includes the aforementioned sole 1. The sole 1 can be constituted by the midsole 20. Accordingly, in the shoe 100, resilience is generated by the twisting deformation in the twisted midsole 20, which can assist the foot movement.

The shoe 100 includes the aforementioned sole 1 and the outer sole 10 that is constituted by a hard member having higher hardness than the midsole 20. The outer sole 10 is disposed under the midsole 20. Accordingly, the durability of the shoe 100 can be improved, and deformation of the shoe 100 in a vertical direction can be restrained.

The midsole 20 can be formed of foam particles. Accordingly, the weight of the midsole 20 can be reduced, and, by using nylon resin or the like, the resilience of the midsole 20 can be improved.

A method for manufacturing the sole 1 includes filling a resin material and forming the midsole 20 as a buffer member. In the filling, a resin material is filled into a mold for the midsole 20 that extends along an axis connecting the toe 20a and the heel 20b and that is twisted around the axis along at least part of the axis. In the forming, the resin material is heated to form the midsole 20. This manufacturing method is suitable for manufacture of the sole 1 including the midsole 20 formed of foam particles of nylon resin.

The present invention has been described with reference to embodiments. The embodiments are intended to be illustrative only, and it will be obvious to those skilled in the art that various modifications and changes could be developed within the scope of claims of the present invention and that such modifications and changes also fall within the scope of claims of the present invention. Therefore, the description in the present specification and the drawings should be regarded as exemplary rather than limitative.

The present invention relates to a sole, a shoe, a method for manufacturing a sole, and a twist control system for a sole.

1. A sole comprising:
a buffer member extending along an axis connecting a toe and a heel, the buffer member being twisted around the axis along at least part of the axis.

2. The sole according to claim 1, wherein the buffer member is twisted medially from a middle part between the toe and the heel toward the heel.

3. The sole according to claim 1, wherein the buffer member is twisted medially from a center of the axis toward the toe.

4. The sole according to claim 1, wherein the buffer member is twisted medially around the axis from a center of the axis toward the heel and twisted medially around the axis from the center of the axis toward the toe.

5. A sole comprising:
a buffer member extending between a toe side and a heel side, the buffer member being formed such that, in a lateral part, the toe side and the heel side are higher than a middle part between the toe side and the heel side.

6. A shoe comprising:
the sole according to claim 1.

7. A shoe, comprising:
the sole according to claim 1; and
an outer sole including a hard member having a hardness higher than a hardness of the buffer member, the outer sole being disposed under the buffer member.

8. The shoe according to claim 6, wherein the buffer member is formed of foam particles.

9. A method for manufacturing a sole, the method comprising:
filling a resin material into a mold for a buffer member extending along an axis connecting a toe and a heel and that is twisted around the axis along at least part of the axis; and
forming the buffer member by heating the resin material.

10. A shoe, comprising:
the sole according to claim 1; and
an actuator configured to change a twist angle of the buffer member.

11. A twist control system for a sole, the twist control system comprising:
the sole according to claim 1;
an actuator configured to change a twist angle of the buffer member;
a controller configured to drive and control the actuator; and
a road surface information device configured to acquire information regarding a road surface with which the sole is in contact, based on position information,
based on the information regarding a road surface acquired by the road surface information device, the controller is configured to change a twist angle.

12. A shoe comprising:
the sole according to claim 5.

13. A shoe, comprising:
the sole according to claim 5; and
an outer sole including a hard member having a hardness higher than a hardness of the buffer member, the outer sole being disposed under the buffer member.

14. The shoe according to claim 7, wherein the buffer member is formed of foam particles.

15. A shoe comprising:
the sole according to claim 2.

16. A shoe, comprising:
the sole according to claim 2; and
an outer sole including a hard member having a hardness higher than a hardness of the buffer member, the outer sole being disposed under the buffer member.
